(19) United States
(12) Patent Application Publication
(10) Pub. No.: US 2026/0359393 A1
(43) Pub. Date: Nov. 12, 2026

(54) METHOD AND SYSTEM FOR GENERATING SESSION REPLAYS

(71) Applicant: DevRev, Inc., Palo Alto, CA (US)

(72) Inventors: Vinay Adapa, Maharashtra (IN); Zeeshan Ali Sayyad, Maharashtra (IN); Bojan Dimovski, Ljubljana (SI); Aman Jain, Mumbai (IN); Uttam Pawar, Maharashtra (IN); Rohan Gupta, Rajasthan (IN)

(73) Assignee: DevRev, Inc., Palo Alto, CA (US)

(21) Appl. No.: 19/438,156

(22) Filed: Dec. 31, 2025

(30) Foreign Application Priority Data
May 9, 2025 (IN) 202541045039

(51) Int. Cl. G06F 17/40; G06F 11/34

(52) U.S. Cl. CPC G06F 17/40; G06F 11/3438

(57) ABSTRACT

A method for generating a session replay representative of one or more user sessions of a user operating on a frontend platform is provided. The method includes generating frames of a screen of a user device based on pixel level changes detected on the screen, during the one or more user sessions on the frontend platform, generating a user event logfile by capturing user events with corresponding time stamps of the user events occurring during the one or more user sessions on the frontend platform, storing the screenshot and the event logfile in the user device, activating a transmission mechanism of the stored frames and the event logfile, and transmitting the stored frames and the user event logfile on demand to a backend platform, for generation of the session replay representing the one or more user sessions on the frontend platform.

### CROSS-REFERENCE TO RELATED APPLICATIONS

The present application claims the benefit of priority to Indian Provisional Application IN 202541045039, filed on May 9, 2025, which is hereby incorporated by reference in its entirety.

### BACKGROUND

The present disclosure is directed to methods and systems for generating on-demand session replays of user sessions.

At the backend of a platform, such as a website, a web application or a mobile application, sessions of users are generally recorded. These session recordings are video recordings of online user interactions on the platform and provide detailed playbacks of user interactions and user events on the platform. The user interactions, for example, include a mouse click, a scroll, a tap, a long press, a change of page or a navigation path.

A user may face an error or a bug while parsing through the many pages of the application. The session recordings play a critical role in identifying the reason for a bug or an error on the platform. For example, session recordings relevant to the bug or the error may be extracted and are played to have insights on the user’s interactions, navigation path of the platform, data inputs to the platform and location/page displaying the bug or error.

The session recordings are also vital for generating insights into the user’s experience, the user’s preferences and navigation path of the user of the platform. For example, the insights may be used to identify reasons for drop-off of a user from an application. While there may be different reasons for the drop-off, one of the reasons may be an error on the website. Another use case of the session recording may include determination of the user’s preferred products being sold on a website.

Recordings of all the user sessions are not performed due to the challenge of data overload. Hence, typically portions of sessions for randomly selected users of the platform are recorded. Another method includes predefining a set of rules for selection of users and/or portions of user sessions. For example, the predefined rules may include recording sessions of a predetermined user segment, such as first-time visitors or high-value customers.

However, the randomly recorded portions of sessions and the usage of the predefined rules do not entirely solve the problem of data overload. Even post usage of the predefined rules or random selection, a huge lot of relevant and irrelevant video recordings are generated. These video recordings create another issue of identifying a relevant video recording for a determined challenge or purpose. Further, since the entire user session is not recorded, relevant session video recordings may get missed out. Hence, current systems that typically rely on predefined sampling rules sometimes end-up overlooking significant user interactions and also miss-out on the most important and relevant sessions.

Therefore, there is a need for generating on-demand session replays to identify errors associated with an application. The session replays are created to ensure that pivotal moments often excluded by automated sampling are retained for the detection of errors.

### SUMMARY

Aspects and advantages of the invention will be set forth in part in the following description, or may be obvious from the description, or may be learned through practice of the invention.

In accordance with an embodiment, a method for generating a session replay representative of one or more user sessions of a user operating on a frontend platform is presented. The method includes generating, by a screenshot capturing subsystem, frames of a screen of a user device based on pixel level changes detected on the screen, during the one or more user sessions on the frontend platform, generating, by an event logfile creation subsystem, a user event logfile by capturing user events with corresponding time stamps of the user events occurring during the one or more user sessions on the frontend platform, storing the frames and the event logfile in the user device, activating, by the user on the frontend platform, a transmission mechanism of the stored frames and the event logfile, and transmitting, by the user device, the stored frames and the user event logfile on demand to a backend platform, for generation of the session replay representing the one or more user sessions on the frontend platform, wherein the session replay is used to identify errors associated with the frontend platform or analyse behaviour of the user on the frontend platform.

In accordance with another embodiment, a method for generating a session replay representative of one or more user sessions of a user on a frontend platform of a user device is presented. The method includes receiving, by a session-replay generation device, frames of a screen of a user device while the user is operating the frontend platform, receiving, by a session-replay generation device, a user event logfile from the frontend platform, and generating, by a session-replay generation device, the session replay based upon the frames and the user event logfile.

In accordance with still another embodiment, a system for generating a session replay is presented. The system includes a screenshot capturing subsystem configured to capture frames of a screen of a user device based on pixel level changes detected on the screen, during one or more user sessions on a frontend platform, an event logfile creation subsystem configured to generate a user event logfile by capturing user events with corresponding time stamps of the events, on the frontend platform, and a data repository allocated to the frontend platform on the user device configured to store the frames and the user event logfile in the frontend platform, a transmission mechanism configured to be activated by the user on the frontend platform to transmit the stored frames and the user event logfile, and a transmitter configured to transmit the stored frames and the user event logfile to a backend platform for generation of the session replay representing the one or more user sessions on the frontend platform, wherein the session replay are used to identify errors associated with the frontend platform or analyse behaviour of the user.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a diagrammatic illustration of a system for generating a session replay, in accordance with one embodiment of the present invention;

FIG. 2 is a block diagram of a system for generating a session replay, in accordance with one embodiment of the present invention;

FIG. 3 is a flowchart of a method for generating, storing and transmitting frames and user event logfile, in accordance with one embodiment of the present invention;

FIG. 4 is a flowchart of a method for generating a session replay, in accordance with one embodiment of the present invention;

FIG. 5 is a flowchart of a method for generating frames, in accordance with one embodiment of the present invention; and

FIG. 6 is a block diagram of an embodiment of a computing device in which the system for generating a session replays described herein are implemented.

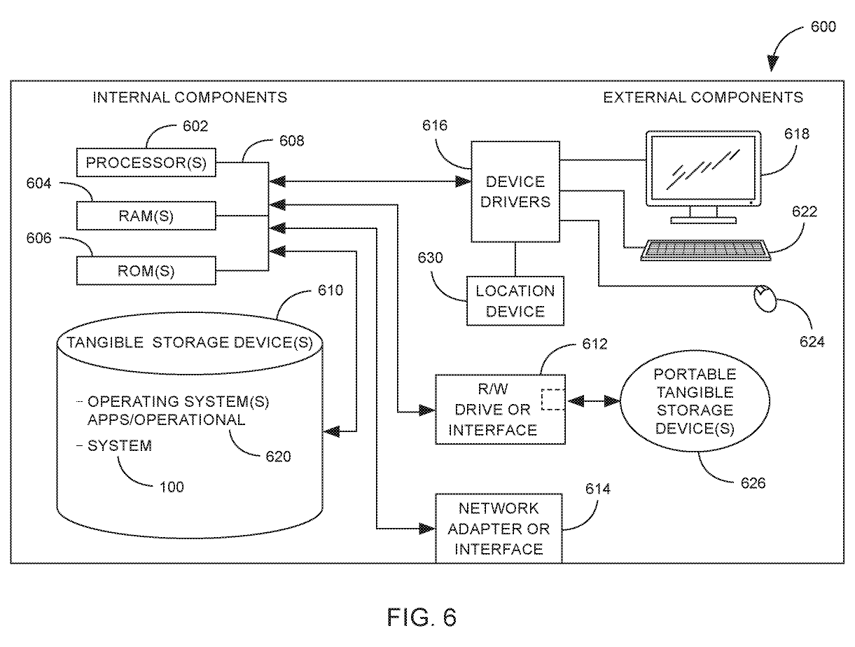

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents. Whereas the preferred form of the invention has been shown and described herein, it should be realized that there may be many modifications, substitutions and alterations thereto.

The present systems and methods generate session replays of user sessions on platforms, such as a website, a webpage, a mobile application, or web application. The session replay represents an entire user session even though an entire video of the user session is not recorded. The present system and method capture frames at specific time stamps to capture each user interaction and user event, and capture platforms’ user interface states (screen layouts, user interface elements). In the presently contemplated configuration, the session replays are created using a combination of frames and a logfile of user events. Hence, even though the session replays give full understanding and information on the user sessions, the size of the session replay file is substantially lower from that of user sessions’ video recordings created by conventional systems. Additionally, due to the low data size of the frames and the logfile of the user events, requirement of transmission bandwidth and storage requirements are low.

Additionally, the present systems and methods generate the session replays when a transmission mechanism is activated by a user on a frontend platform of a mobile application or a web application. The session replays are generated on-demand. Hence, the frames and the logfile are only transmitted when required by the team for resolving error issues with the mobile application or the web application.

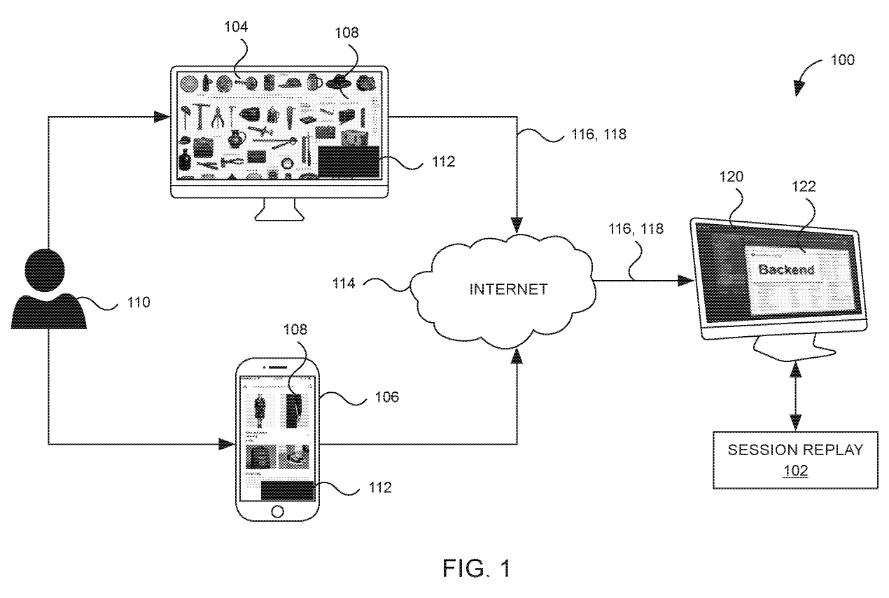

FIG. 1 is a diagrammatic illustration of a system 100 for generating a session replay 102, in accordance with one embodiment of the present invention. Reference numeral 104 and 106 are representative of user devices. Reference numeral 104 represents a computing system, such as a laptop or a desktop. Reference numeral 106 represents a mobile. In the presently contemplated configuration, both the computing system 104 and the mobile 106 are configured with a frontend platform 108. The frontend platform 108 for example may be a website, a webpage, a web browser, a web application, or a mobile application. A user 110 uses the frontend platform 108 to access desired services and/or buy products offered on the frontend platform 108. For example, the frontend platform 108 may be a food delivery or a product delivery webpage or application. The frontend platform 108 records user interactions and user events performed by the user 110 on the frontend platform 108. As used herein, the term “record” refers to capturing of frames and user events during a user session on the frontend platform 108. It is noted that the term “record” does not refer to video recording of the user session on the frontend platform 108. For example, a user session starts at a time stamp when the user 110 starts using the frontend platform 108 and ends when the user 110 drops off from the frontend platform 108. For example, during the user session, the user may login to the frontend platform 108, enter data, click multiple times, perform long presses, buy some services or products, and do multiple such interactions with the frontend platform 108. These interactions with the frontend platform 108 during the user session are referred to as user interactions. Additionally, multiple events may be performed by the user such as a change of a webpage, login to the frontend platform 108, navigation between screen transitions, taps, swipes, long presses, and other gestures. These events on the frontend platform 108 during the user session are referred to as “user events.”

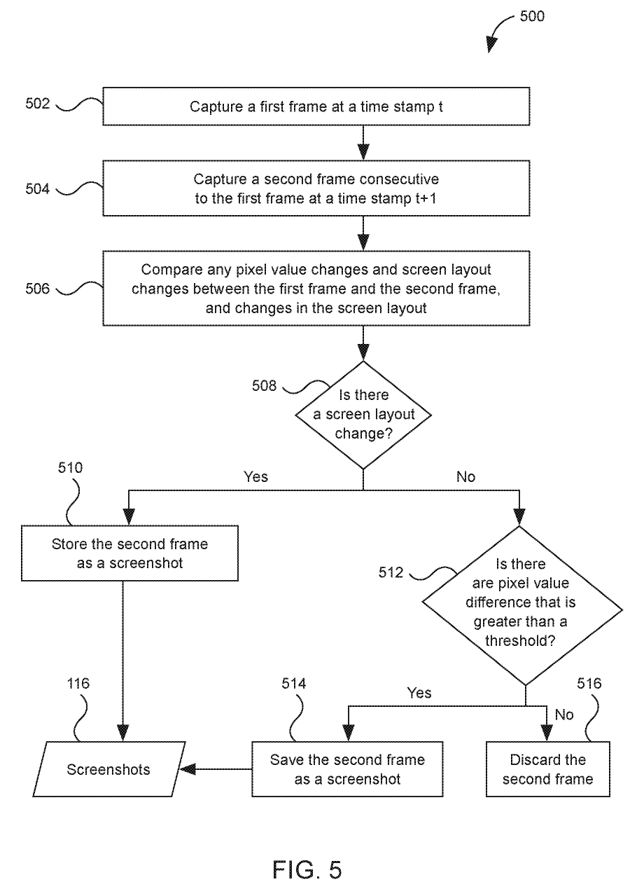

The frontend platform 108 clicks multiple photos/frames of the screen of the user device 104, 106 during the ongoing user session. However, in the presently contemplated configuration, the frontend platform 108 does not capture all the possible frames/user sessions during the ongoing user session. In the presently contemplated configuration, during the user session, frames 116 of the screen of the frontend platform 108 are captured based on pixel level changes detected on the screen. Particularly, the frames 116 are captured when pixel-level differences and changes are detected on the screen of the frontend platform 108 during the user session. In other words, whenever a change in pixel values on the screen is detected, a screenshot of the screen is captured by the frontend platform 108 or a component of the frontend platform 108. A method of capturing the frames will be explained in greater detail with reference to FIG. 5.

The pixel level changes or the change in the pixel values is detected in real time during the ongoing user session. In one embodiment, capturing of the frames 116 is initiated subsequent to the activation of the on-demand user session. The frames 116 are autonomously and automatically captured by the frontend platform 108 subsequent to activation of the on-demand user session. The frames 116 comprise different screen states, touch points, gestures, text inputs, screen and pixel changes, taps, swipes, long presses, screen transitions, navigation between different screens or webpages, button clicks, form inputs, scrolls, text inputs, or combinations thereof.

Furthermore, a user event logfile 118 is generated by capturing the user events with corresponding time stamps of the user events during the user session. The user event logfile 118 includes entries of the type of event, time stamp when the event occurred and position of the mouse or cursor. The frames 116 and the user event logfile 118, for example may be stored in a local storage device of the user device 104, 106. For example, the local storage may be Random Access Memory (RAM). The frames 116 and the user event logfile 118 may be stored in a volatile memory as well.

The frontend platform 108 additionally includes a transmission mechanism 112 configured to activate transmission of the stored frames 116 and the event logfile 118. The user 110, of the frontend platform 108 activates the transmission mechanism 112 on the frontend platform 108. The transmission mechanism, for example may be a button or a switch available on the frontend platform 108.

Subsequent to the activation of the transmission mechanism 112, the frames 116 and the user event logfile 118 are transmitted to a session-replay generation device 120 via internet 114. The frames 116 and the user event logfile 118 are received by the session-replay generation device 120. The session-replay generation device 120, for example is a backend server 120. The session-replay generation device 120 has a backend platform 122 that provides an interface to a team for accessing the frames 116 and the user event logfile 118. The session-replay generation device 120 generates the session replay 102 based on the frames 116 and the user event logfile 118. While the session replay 102 is not a video recording of the user session, the session replay 102 represents the user session on the frontend platform 108. Particularly, the session replay 102 mimics the user’s 110 session. The session replay 102 is generated based on the frames 116 and the user event logfile 118. The session replay 102 is generated by applying one or more advanced rendering techniques on the frames 116 and the user event logfile 118. The frames 116 and the user events in the user event logfile 118 are synchronized in time stamps for generation of the session replay 102. The capturing of the frames, and time synchronization of the frames 116 with the user events ensures an accurate and true-to-life visual replay of the user session.

The session replay 102 mimics the user actions, performed during the user session, without the need to record actual video of the user session. By focusing on significant screen changes and minimizing redundant screenshot/frame capture, the present systems and methods provide for efficient data storage and transmission, while providing detailed insights into the user’s 110 behaviour and performance of the frontend platform 106. The session replay 102 provides a visual account of the user’s 110 interactions for streamlining root cause analysis of an error on the frontend platform 106. A team may be able to decipher the user’s 110 experience on the frontend platform 108 without an extensive follow-up questioning. This allows for a quicker understanding and resolution of any challenges or issues with the frontend platform 108. This understanding minimizes any possible ambiguity, and accelerates the replication of the challenges or issues, and the implementation of fixes on the frontend platform 108.

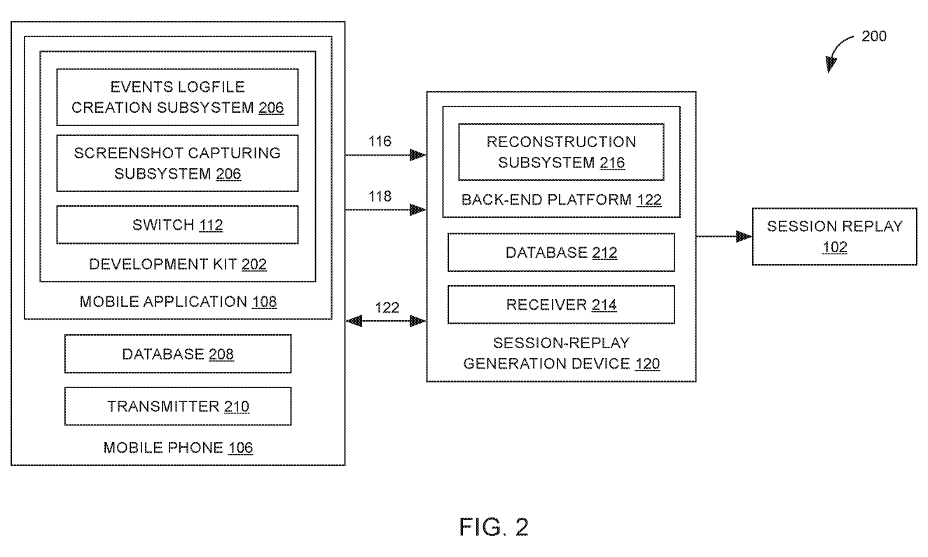

FIG. 2 is a block diagram of a system 200 for generating the session replay 102, in accordance with one embodiment of the present invention. In the presently contemplated example, the user device 106 referred to in FIG. 1 is a mobile phone. The frontend platform 108 also shown in FIG. 1 is installed on the user device 106. The frontend platform 108, for example is a mobile application. The mobile application 108 includes a development kit 202 configured to capture the frames 116 (see FIG. 1) and the user events 118 (see FIG. 1). In one embodiment, the development kit 202 may be a microprocessor, a system on a chip, a digital signal processor, or the like. In alternative embodiment, the development kit 202 may be a software development kit integrated within the frontend platform 108. The development kit 202 at least includes the transmission mechanism (switch) 112 (see FIG. 1), a screenshot capturing subsystem 204, and an events logfile creation subsystem 206. The screenshot capturing subsystem 204 captures the frames 116 of the screen of the frontend platform 108 during an ongoing user session. Furthermore, the events logfile creation subsystem 206 generates the user event logfile 118 by capturing the user events with corresponding time stamps of the events. The user events logfile 118 is created during the ongoing user session when the user 110 (see FIG. 1) is using the mobile application 108 on the mobile phone 106. The user events logfile 118 for example may be a table including names of user events, time stamp for each of the events, details of webpage, and the like.

The frames 116 and the user event logfile 118 are stored in a database 208 of the mobile phone 106. The database 208, for example, may be Random Access Memory, local storage, or the like. In alternative embodiments, the frames 116 and the user event log file 118 may be stored on a cloud space. In one embodiment, the frames 116 and the user event logfile 118 are stored in a portion of the database 208 allocated to the frontend platform 108.

The mobile application 108 additionally includes a transmission mechanism 112 configured to activate transmission of the stored frames and the event logfile. The user of the frontend platform activates the transmission mechanism 112 on the frontend platform 108. The transmission mechanism 112, for example may be a button or a switch available on the frontend platform 108.

Subsequent to activation of the transmission mechanism 112, the frames 116 and the user event logfile 118 are transmitted to the session-replay generation device 120. As shown in FIG. 2, the mobile phone 106 additionally includes a transmitter 210 that transmits the frames 116 and the user event logfile 118 to the session-replay generation device 120 (also see FIG. 1). The session replay generation device 120 is managed by a team that accesses the backend platform 122 (also see FIG. 1) of the session-replay generation device 122. As previously noted, the session-replay generation device 120 may be a server integrated with the backend platform 122. The session-replay generation device 120 includes a database 212 and a receiver 214. The frames 116 and the user event logfile 118 are received by the receiver 214, and stored in the database 212.

As shown in FIG. 2, the backend platform 122 includes a reconstruction subsystem 216 that retrieves the frames 116 and the user event logfile 118 from the database 212. Furthermore, the reconstruction subsystem 216 generates the session replay 102 based on the frames 116 and user event logfile 118. The session replay 102 is created by applying advanced rendering techniques on the frames 116 and the logfile 118. In one embodiment, the reconstruction subsystem 216 may be a microprocessor, a system on a chip, a digital signal processor, or the like. In alternative embodiment, the reconstruction subsystem 216 may be a module integrated within the backend platform 122.

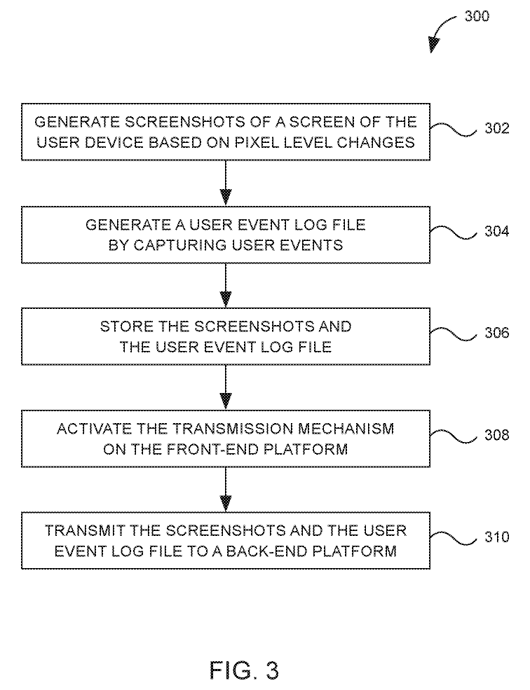

FIG. 3 is a flowchart of a method 300 for generating session replays, in accordance with one embodiment of the present invention. At block 302, frames of a screen of the user device are generated. The frames, for example, may be the frames 116 referred to in FIG. 1. The frames are captured on the frontend platform open on the screen of the user device. During an ongoing user session, frames of the user session of the frontend platform are captured based on pixel level changes detected on the screen of the user device. In one embodiment, only those frames are captured in real-time during an on-going session that shows a pre-determined level of change in pixel values with respect to a previously captured screenshot. In an alternative embodiment, only those frames are captured, in real-time, during an on-going session that show a change in the screen layout. Generation of the frames is explained in greater detail with reference to FIG. 5.

At block 304, a user event logfile is generated. The user event logfile is generated by continuously capturing user events, in real time, during an ongoing user session. For example, if a user clicks in a page of a mobile application at a time stamp 2.04, an entry of the click is made by capturing the event name “click” with corresponding time stamp “2.02” in a logfile. In a similar manner, the entries of user events along with corresponding time stamps are continuously made into the user event logfile until the end of the ongoing user session. The user event logfile, for example, may be generated by capturing user events in a predetermined format. For example, the user event logfile may be created in a tabular format including details of user events with corresponding time stamps. By way of a non-limiting example, the user events may include a change of a web page, a click, a long press, a text input, and the like on the frontend platform. It is noted that while block 306 is shown subsequent to block 304, steps 304 and 306 are simultaneously executed. At block 306, the frames and the user event logfile are stored in a data repository. In one embodiment, the data repository, for example may be a data repository on the mobile device having the frontend platform 108 (mobile application). In another embodiment, the data repository may be on a computer system when the frontend platform 108 is a web application. At block 308, the transmission mechanism 112 on the frontend platform 108 may be activated. The transmission mechanism 112, for example may be a button or a switch available on the frontend platform 108.

At block 310, the frames and the user event logfile are transmitted to a backend platform. The frames and the user event logfile, for example may be transmitted by a transmitter of the user device running the frontend platform. The backend platform, for example may be the backend platform 122 referred to in FIG. 1 that is operated by a team of an application provider. The backend platform 122 is available at another location with respect to that of the location of the frontend platform.

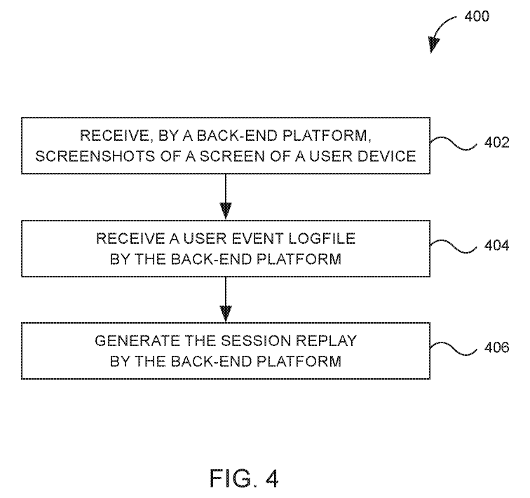

FIG. 4 is a flowchart of a method 400 for generating a session replay, in accordance with one embodiment of the present invention. The method 400 shows steps that are executed at an application provider’s level. At block 402, frames are received by a backend platform transmitted by the user device. Similarly, at block 404, a user event logfile is received by the backend platform transmitted by the user device. At block 406, a session replay of the user session is generated based on the frames and the user event logfile. The session replay is generated by synchronizing the user events in the user event logfile and the frames in time stamps.

FIG. 5 is a flowchart of a method 500 for generating frames, in accordance with one embodiment of the present invention. The method 500 is explained for generation of the frames 116 referred to in FIG. 1. The method explained in FIG. 5 is repeated until the end of an ongoing user session. In the presently contemplated configuration consecutively captured frames during an ongoing user session are compared to determine a change in pixel value and screen layout. The steps of FIG. 5, for example, are executed by the screenshot capturing subsystem 204 (see FIG. 2) in combination with one or more components of the user device 104, 106.

At step 502, a first frame is captured, during the ongoing user session, at a time stamp ‘t’. The first frame is stored as one of the frames 116. At step 504, a frame consecutive to the first frame is captured at a time stamp ‘t+1’. The frame consecutive to the first frame is hereinafter referred to as a “second frame.” In one embodiment, the first frame and the second frame are captured by the user device 104, 106. In an alternative embodiment, the first frame and the second frame are initiated and/or captured by the frontend platform 108.

At step 506, a comparison between the first frame and the second frame is performed. The comparison is performed to determine a difference between the first frame and the second frame. The difference between the first frame and the second frame may be in the screen layout due to a change in the web page, or the change may be in the pixel values due to one or more user interaction or user events.

At block 508, a decision is made whether there is a screen layout change between the first frame and the second frame. At block 508, when it is determined that a screen layout change exists between the first frame and the second frame, the control is transferred to block 510. At block 510, the second frame is stored as one of the frames 116 consecutive to the first frame/screenshot.

Referring back to block 508, when it is determined that a change in the screen layout does not exist, the control is transferred to block 512. At block 512, it is determined whether one or more of the pixel values are greater than a predetermined threshold. At block 512, when it is determined that the pixel value difference is greater than a predetermined threshold, the control is transferred to block 514. At block 514, the second frame is saved as one of the frames 116. Referring back to block 512, when it is determined that the pixel value difference is not greater than the predetermined threshold, the control is transferred to step block 516. At block 516, the second frame is discarded. The method 500 is repeated multiple times for each consecutive frame until the end of the user session.

The present system and method empowers the team to receive frames and user events on-demand, bypassing default sampling criteria that may otherwise miss critical sessions. Hence, the receipt of the frames and the user events are a user-controlled feature that ensures that essential user interactions are captured, allowing for accurate troubleshooting and comprehensive support.

The present system and method generate a session replay representing an entire user session even though an entire video of the user session is not recorded. The present system and method capture frames, at specific time stamps that meet a certain criterion, to capture each user interaction and user event, and captures platforms’ user interface states (screen layouts, user interface elements). A session replay is reconstructed from such frames and user events. Since the entire user session is not recorded, and specific frames and user events are used to reconstruct the session replay, the size of the session replay is substantially less than a recorded video of a user session.

Instead of storing every frame, the present system and method uses respective image processing methods to optimize data storage and yet not miss-out on important and relevant portions of a user session. Due to the usage of specific frames capturing, usage of on-demand screenshot transmission, and specific image processing technique, only essential data is stored and uploaded, minimising impacts on device memory and network resources. On-demand screenshot and user event logfile transmission receive prioritised processing, ensuring that support for significant application issues faced by a user of an application is prompt and efficient.

The captured user session allows for observation of user behaviour in real-world contexts. The session replay enables product teams of application providers to gain insights into common pain points, navigation patterns, and potential areas for improvement. For example, the session replays generated by the present systems and methods highlight friction points, drop-offs, or navigation confusion, and offer actionable data that guides product development and usability enhancements.

Session replays enable teams to analyse user journey funnels, and identify where users abandon tasks. The visual data helps pinpoint exact moments of drop-off, allowing targeted optimizations that improve conversion rates, reduce churn, and increase engagement metrics.

The techniques and systems described herein is implemented using a computing device such as computing device 600 is described below in FIG. 5. The computing device 600 includes one or more processor(s) 602, one or more computer-readable RAMs 604 and one or more computer-readable ROMs 606 on one or more buses 608. Further, computing device 600 includes a tangible storage device 610 that includes operating system 620. The operating systems 620 are executed by the one or more processor(s) 602 via one or more respective RAMs 604 (which typically include cache memory). The execution of the operating systems 620 by the one or more processor(s) configures the one or more processor(s) as a special purpose processor configured to carry out upgrade operations described above.

Examples of the tangible storage device include semiconductor storage devices such as ROM, EPROM, flash memory or any other computer-readable tangible storage device that may store a computer program and digital information.

Computing device 600 also includes a R/W drive or interface 612 to read from and write to one or more portable computer-readable tangible storage devices 96 such as a CD-ROM, DVD, memory stick or semiconductor storage device. Further, network adapters or interfaces 614 such as a TCP/IP adapter cards, wireless Wi-Fi interface cards, or 3G or 4G wireless interface cards or other wired or wireless communication links are also included in computing device.

Computing device 600 further includes device drivers 616 to interface with input and output devices. The input and output devices may include a computer display monitor 618, a keyboard 622, a keypad, a touch screen, a computer mouse 624, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to embodiments containing only one such recitation, even when the same claim includes the introductory phrases "one or more" or "at least one" and indefinite articles such as "a" or "an" (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of "two recitations," without other modifiers, means at least two recitations, or two or more recitations).

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device main body or a removable medium arranged so that it may be separated from the computer device main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

1. A method for generating a session replay representative of one or more user sessions of a user operating on a frontend platform, the method comprising:
generating, by a screenshot capturing subsystem, frames of a screen of a user device based on pixel level changes detected on the screen, during the one or more user sessions on the frontend platform;
generating, by an event logfile creation subsystem, a user event logfile by capturing user events with corresponding time stamps of the user events occurring during the one or more user sessions on the frontend platform;
storing the frames and the event logfile in the user device;
activating a transmission mechanism of the stored frames and the event logfile; and
transmitting, by the user device, the stored frames and the user event logfile on demand to a backend platform, for generation of the session replay representing the one or more user sessions on the frontend platform,
wherein the session replay is used to identify errors associated with the frontend platform or analyse behaviour of the user on the frontend platform.

2. The method as claimed in claim 1, further comprising:
receiving, by a session replay device, the frames and the user event logfile from the frontend platform; and
generating, by the backend platform, the session replay based on the frames and the user event logfile.

3. The method as claimed in claim 2, further comprising generating the session replay by applying one or more advanced rendering techniques on the frames and the user event logfile,
wherein generating the session replay comprises synchronizing the user events in the user event logfile and the frames in time stamps.

4. The method as claimed in claim 1, wherein transmitting of the stored frames and the user event logfile is initiated in response to activation of the transmission mechanism by the user.

5. The method as claimed in claim 1, wherein the frames comprise different screen states, touch points, gestures, text inputs, screen and pixel changes, taps, swipes, long presses, screen transitions, navigation between different screens or webpages, button clicks, form inputs, scrolls, or combinations thereof.

6. The method as claimed in claim 1, further comprising autonomously and automatically capturing the frames by the user device.

7. A method for generating a session replay representative of one or more user sessions of a user on a frontend platform of a user device, the method comprising:
receiving, by a session-replay generation device, stored frames and a user event logfile from the frontend platform; and
generating, by a session-replay generation device, the session replay based upon the frames and the user event logfile.

8. The method as claimed in claim 7, wherein the backend platform receives the frames and the user event logfile subsequent to activation of the transmission mechanism on the frontend platform.

9. The method as claimed in claim 7, wherein the frames are captured by the frontend platform based on pixel level changes detected on the screen, during one or more user sessions on the frontend platform,
wherein the user event logfile is generated by capturing user events with corresponding time stamps of the user events occurring during the one or more sessions on the frontend platform.

10. The method as claimed in claim 7, wherein generating the session replay comprises synchronizing the user events in the user event logfile and the frames in time stamps.

11. A system for generating a session replay, comprising:
a screenshot capturing subsystem configured to capture frames of a screen of a user device based on pixel level changes detected on the screen, during one or more user sessions on a frontend platform;
an event logfile creation subsystem configured to generate a user event logfile by capturing user events with corresponding time stamps of the events, on the frontend platform;
a data repository allocated to the frontend platform on the user device configured to store the frames and the user event logfile in the frontend platform; and
a transmission mechanism configured to transmit the stored frames and the user event logfile to a backend platform for generation of the session replay representing the one or more user sessions on the frontend platform,
wherein the session replay is used to identify errors associated with the frontend platform or analyse behaviour of the user.

12. The system as claimed in claim 11, wherein the frontend platform comprises one of a website, a webpage, a web browser, a web application, or a mobile application, and the backend platform comprises a backend web browser or a backend application in a server.

13. The system as claimed in claim 11, wherein the user device comprises a mobile device or a computing device.

14. The system as claimed in claim 11, wherein the backend platform is configured to receive the frames and the user event logfile subsequent to activation of the transmission mechanism on the frontend platform.

15. The system as claimed in claim 11, further comprising a session-replay generation device in the backend platform configured to:
receive the stored frames and the user event logfile from the frontend platform; and
generate the session replay based upon the received frames and the user event logfile.

16. The system as claimed in claim 15, wherein the session-replay generation device in the backend platform is configured to generate the session replay by synchronizing the user events in the user event logfile and the frames in time stamps.

17. The system as claimed in claim 11, wherein the frontend platform is configured to capture the frames based on pixel level changes detected on the screen, during one or more user sessions on the frontend platform,
wherein the user event logfile is generated by capturing user events with corresponding time stamps of the user events occurring during the one or more sessions on the frontend platform.
